(19) United States
(12) Patent Application Publication
(10) Pub. No.: US 2022/0387887 A1
(43) Pub. Date: Dec. 8, 2022

(54) GAME CONTENT CHOREOGRAPHY BASED ON GAME CONTEXT USING SEMANTIC NATURAL LANGUAGE PROCESSING AND MACHINE LEARNING

(71) Applicant: GOOGLE LLC, Mountain View, CA (US)

(72) Inventor: Anna Kipnis, San Bruno, CA (US)

(21) Appl. No.: 17/789,355

(22) PCT Filed: Apr. 30, 2020
(86) PCT No.: PCT/US2020/030672

§ 371 Date: Jun. 27, 2022

Related U.S. Application Data
(60) Provisional application No. 62/989,211, filed on Mar. 13, 2020.

(51) Int. Cl. A63F 13/42; G06F 40/30

(52) U.S. Cl. CPC A63F 13/42; G06F 40/30; A63F 2300/6045

(57) ABSTRACT

A module that implements a state machine generates a first environmental condition experienced by a player in a video game. The first environmental condition is produced by the module operating in a first state of the state machine and the first state is associated with a first natural language tag. The state machine transitions from the first state to a second state based on a semantic similarity of an input phrase and a second natural language tag associated with the second state. The module, while operating in the second state, generates a second environmental condition experienced by the player in the video game. In some cases, the module selects the second natural language tag based on a ranking of tags for a plurality of states on their semantic similarity to an input phrase. The ranking is generated by a semantic natural language processing (NLP) machine learning (ML) algorithm.

### BACKGROUND

Video games typically implement a set of modules to control the environment surrounding characters in the game. Examples of the modules include a weather module to determine the weather experienced by the character, a music module to provide different types of background music, an audio module to provide sound effects, an animation module to generate animations for characters such as nonplayer characters (NPCs) that interact with the player, a tiling module to determine characteristics of procedural world tiles that represent a map of an area being explored by the player, and the like. Game developers that want to implement a dynamic environment are required to author explicit connections and rules that determine how the modules respond to input stimuli. For example, the weather module can be scripted to provide different weather conditions depending on a season or other game state information, the music module can be scripted to provide music reflecting different emotions associated with the players character or relationships, the audio module can be scripted to provide different sound effects for the same action such as a “crunchy” sound for footsteps over snow and a “squishy” sound for footsteps in a swamp, the animation module can be scripted to render different animations for an NPC based on mood or health, and the tiling module can be scripted to provide different characteristics depending on the game state. Associating a wide range of stimuli with a correspondingly wide range of responses requires significant development resources to create and update the rules or to expose an editing mechanism to allow non-programmers to create and update the rules. Moreover, the resulting game systems are bespoke and new game systems are authored from scratch for each new game. And even if the necessary resources are available to develop the bespoke game system, the system is unlikely to account for all possible behaviors that emerge during actual gameplay.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that performs game content choreography based on game context using a semantic natural language processing (NLP) machine learning (ML) algorithm according to some embodiments.

FIG. 2 is a block diagram of a cloud-based system that performs game content choreography based on game context according to some embodiments.

FIG. 3 is a block diagram of a gaming system that includes a set of modules for providing different environmental conditions within a video game executing on the gaming system according to some embodiments.

FIG. 4 is a block diagram of a state machine implemented in a module of a video game according to some embodiments.

FIG. 5 is a block diagram of an instance of a semantic NLP ML algorithm that generates initial scores for responses to an input phrase according to some embodiments.

FIG. 6 is a flow diagram of a method of modifying the state of a state machine that represents environmental conditions in a video game based on ranked tags of the states of the state machine according to some embodiments.

FIG. 7 is a flow diagram of a method for re-ranking results returned by a semantic NLP ML algorithm for a set of rules according to some embodiments.

FIG. 8 is a flow diagram of a method for re-ranking results returned by a semantic NLP ML algorithm for a single rule according to some embodiments.

FIG. 9 is a flow diagram of a method for re-ranking results returned by a semantic NLP ML algorithm for a set of rules according to some embodiments.

### DETAILED DESCRIPTION

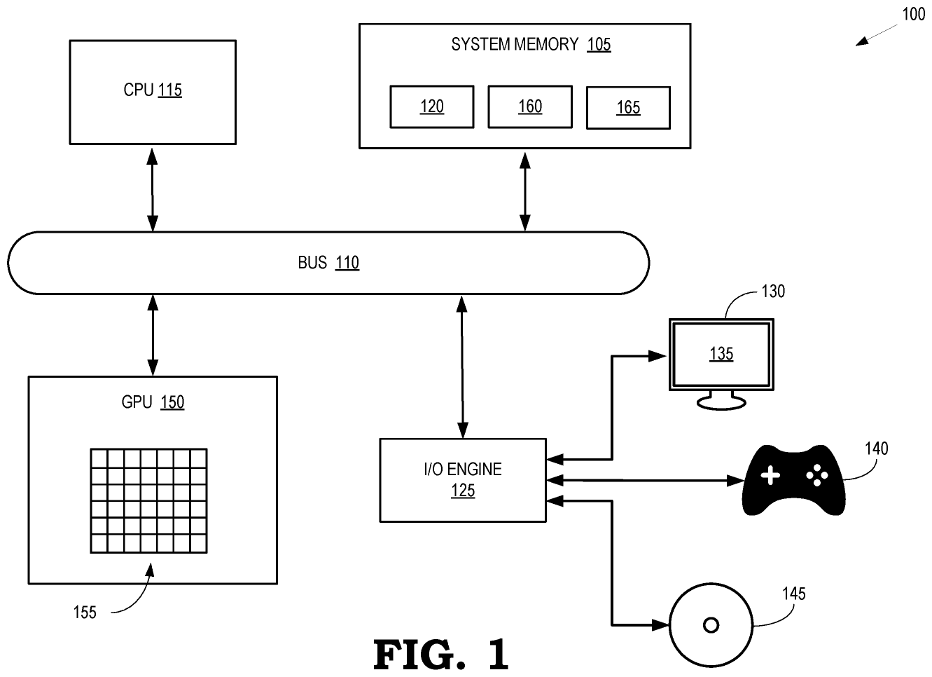

FIGS. 1-9 disclose techniques for choreographing content generated by modules that create the environmental conditions experienced by a player in a video game based on natural language tags associated with game settings that are associated with each of the modules. Some embodiments of the modules are implemented as state machines that include states defined by different combinations of game settings. The states of the state machines are associated with natural language phrases that are representative of the corresponding states, which are referred to herein as the tags of the states. For example, a “sunny” state of the weather module would include settings for blue sky, bright sunshine, light breezes, and the like. A “stormy” state of the weather module would include settings for heavy rolling clouds, darkness or flat light, strong gusty winds, falling rain, and the like. The module implements a semantic natural language processing (NLP) machine learning (ML) algorithm to determine transitions between the states based on input phrases that represent a current game state. A semantic NLP ML algorithm operating in a semantic similarity modality returns scores that represent the semantic similarity of an input phrase to the tags of the states of the state machine implemented by the module. The module transitions the state machine to the state that has the highest score indicating that the state is most similar to the input phrase. For example, if the music module receives an input phrase “Mario is reunited with Peach,” the semantic NLP ML algorithm returns a high score for the tag “joyful.” The module therefore transitions to the state that is tagged with the phrase “joyful” and the module provides joyful background music. In some embodiments, the modules receive input from a predetermined subset of sources of natural language phrases that represent different aspects of the game state. For example, the music module can monitor natural language phrases that indicate changes in the status of relationships between the characters.

In some embodiments, a game developer modifies rankings provided by the semantic NLP ML algorithm in a post-processing step to modify the outcomes put into action by a module. For example, the semantic NLP ML algorithm is likely to associate the phrase “sad music” with the phrase “the killing of lots of characters” due to the relatively high semantic association of these two phrases. However, in the context of a video game, the phrase “the killing of lots of characters” may indicate a triumphant moment and not a sad moment. The game developer therefore defines one or more rules to modify the results provided by the semantic NLP ML algorithm based on alternate associations of phrases that represent the game state and the tags of the states of the state machines implemented in the modules. For example, the game developer can define a rule that biases the ranking of the phrase “the killing of lots of characters” so that this phrase has a stronger semantic association with the phrase “triumphant music.” Thus, re-ranking allows game developers to use fuzzy matching and natural language to control the outcome of the semantic NLP ML algorithm to match the needs of the module in the video game.

FIG. 1 is a block diagram of a processing system 100 that performs game content choreography based on game context using a semantic natural language processing (NLP) machine learning (ML) algorithm according to some embodiments. The processing system 100 includes or has access to a memory 105 or other storage component that is implemented using a non-transitory computer readable medium such as a dynamic random-access memory (DRAM). However, some embodiments of the memory 105 are implemented using other types of memory including static RAM (SRAM), nonvolatile RAM, and the like. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The processing system 100 includes a central processing unit (CPU) 115. Some embodiments of the CPU 115 include multiple processing elements (not shown in FIG. 1 in the interest of clarity) that execute instructions concurrently or in parallel. The processing elements are referred to as processor cores, compute units, or using other terms. The CPU 115 is connected to the bus 110 and the CPU 115 communicates with the memory 105 via the bus 110. The CPU 115 executes instructions such as program code 120 stored in the memory 105 and the CPU 115 stores information in the memory 105 such as the results of the executed instructions. The CPU 115 is also able to initiate graphics processing by issuing draw calls.

An input/output (I/O) engine 125 handles input or output operations associated with a display 130 that presents images or video on a screen 135. In the illustrated embodiment, the I/O engine 125 is connected to a game controller 140 which provides control signals to the I/O engine 125 in response to a user pressing one or more buttons on the game controller 140 or interacting with the game controller 140 in other ways, e.g., using motions that are detected by an accelerometer. The I/O engine 125 also provides signals to the game controller 140 to trigger responses in the game controller 140 such as vibrations, illuminating lights, and the like. In the illustrated embodiment, the I/O engine 125 reads information stored on an external storage component 145, which is implemented using a non-transitory computer readable medium such as a compact disk (CD), a digital video disc (DVD), and the like. The I/O engine 125 also writes information to the external storage component 145, such as the results of processing by the CPU 115. Some embodiments of the I/O engine 125 are coupled to other elements of the processing system 100 such as keyboards, mice, printers, external disks, and the like. The I/O engine 125 is coupled to the bus 110 so that the I/O engine 125 communicates with the memory 105, the CPU 115, or other entities that are connected to the bus 110.

The processing system 100 includes at least one graphics processing unit (GPU) 150 that renders images for presentation on the screen 135 of the display 130, e.g., by controlling pixels that make up the screen 135. For example, the GPU 150 renders visual content to produce values of pixels that are provided to the display 130, which uses the pixel values to display an image that represents the rendered visual content. The GPU 150 includes one or more processing elements such as an array 155 of compute units that execute instructions concurrently or in parallel. Some embodiments of the GPU 150 are used for general purpose computing. In the illustrated embodiment, the GPU 150 communicates with the memory 105 (and other entities that are connected to the bus 110) over the bus 110. However, some embodiments of the GPU 150 communicate with the memory 105 over a direct connection or via other buses, bridges, switches, routers, and the like. The GPU 150 executes instructions stored in the memory 105 and the GPU 150 stores information in the memory 105 such as the results of the executed instructions. For example, the memory 105 stores instructions that represent a program code 160 that is to be executed by the GPU 150.

The CPU 115, the GPU 150, or a combination thereof execute the program code 160 to create a video game that is played by one or more players. The CPU 115, the GPU 150, or a combination thereof also implement a state machine that generates a first environmental condition experienced by one or more players while playing the video game. The first environmental condition is produced by the module operating in a first state of the state machine and the first state is associated with a first natural language tag. The state machine transitions from the first state to a second state based on a semantic similarity of an input phrase and a second natural language tag associated with the second state. The module, while operating in the second state, generates a second environmental condition experienced by the player in the video game.

Some embodiments of the module select the second natural language tag based on a ranking of tags for a plurality of states on their semantic similarity to an input phrase. The ranking is generated by a semantic natural language processing (NLP) machine learning (ML) algorithm. For example, the CPU 115, the GPU 150, or a combination thereof can execute machine learning algorithms such as a semantic NLP ML algorithm. In the illustrated embodiment, the memory 105 stores a program code that represents a semantic NLP ML algorithm 165 that has been trained using a corpus of natural language data. Many text corpuses are available for training machine learning algorithms including corpuses related to media/product reviews, news articles, email/spam/newsgroup messages, tweets, dialogues, and the like. The CPU 115, and/or the GPU 150 (or one or more of the compute units in the array 155) executes the program code that represents the trained semantic NLP ML algorithm 165 in either input/response modality or a semantic similarity modality to generate scores that represent a degree of matching between candidate responses and an input phrase.

In the semantic similarity modality, the trained semantic NLP ML algorithm 165 represents a corpus as a graph including words or phrases at the nodes of the graph that are connected by edges. Semantic similarity between two words or phrases is determined by a distance metric that indicates a distance between the two words or phrases. In some embodiments, the distance metric is computed by the trained semantic NLP ML algorithm 165 using weights that are assigned to the edges connecting the nodes in the graph during training of the semantic NLP ML algorithm 165. In the input/response modality, the trained semantic NLP ML algorithm 165 uses the graph of the words or phrases to determine values of metrics that indicate a likelihood that an input word or phrase is followed by a response word or phrase. In some embodiments, the values of the metrics are determined using weights that are assigned to the edges connecting the nodes in the graph during training of the semantic NLP ML algorithm 165.

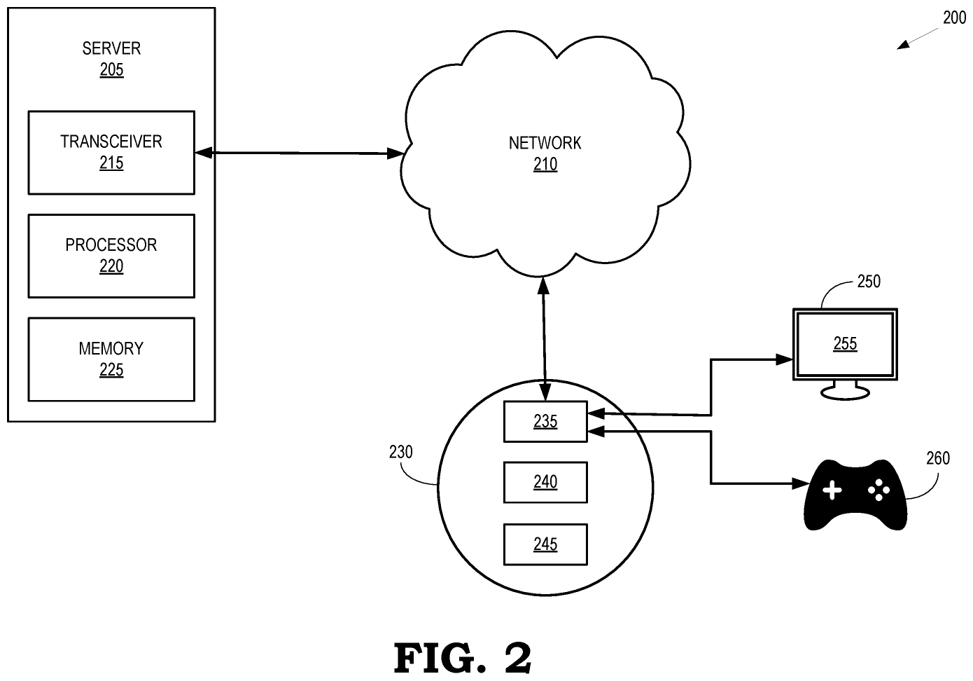

FIG. 2 is a block diagram of a cloud-based system 200 that performs game content choreography based on game context according to some embodiments. The cloud-based system 200 includes a server 205 that is interconnected with a network 210. Although a single server 205 shown in FIG. 2, some embodiments of the cloud-based system 200 include more than one server connected to the network 210. In the illustrated embodiment, the server 205 includes a transceiver 215 that transmits signals towards the network 210 and receives signals from the network 210. The transceiver 215 can be implemented using one or more separate transmitters and receivers. The server 205 also includes one or more processors 220 and one or more memories 225. The processor 220 executes instructions such as program code stored in the memory 225 and the processor 220 stores information in the memory 225 such as the results of the executed instructions.

The cloud-based system 200 includes one or more processing devices 230 such as a computer, set-top box, gaming console, and the like that are connected to the server 205 via the network 210. In the illustrated embodiment, the processing device 230 includes a transceiver 235 that transmits signals towards the network 210 and receives signals from the network 210. The transceiver 235 can be implemented using one or more separate transmitters and receivers. The processing device 230 also includes one or more processors 240 and one or more memories 245. The processor 240 executes instructions such as program code stored in the memory 245 and the processor 240 stores information in the memory 245 such as the results of the executed instructions. The transceiver 235 is connected to a display 250 that displays images or video on a screen 255 and a game controller 260. Some embodiments of the cloud-based system 200 are therefore used by cloud-based game streaming applications.

The processor 220, the processor 240, or a combination thereof execute program code representative of one or more modules that are executed to provide a game environment based on states of the corresponding state machines, as discussed herein. Some embodiments of the program code include code representative of a semantic NLP ML algorithm that operates in either input/response modality or a semantic similarity modality. As discussed herein, the semantic NLP ML algorithm is pre-trained using one or more text corpuses. The modules transition between the states of the state machines based on the rankings generated by the semantic NLP ML algorithm. In some embodiments, the rankings generated by the semantic NLP ML algorithm are modified based on a set of rules, as discussed herein.

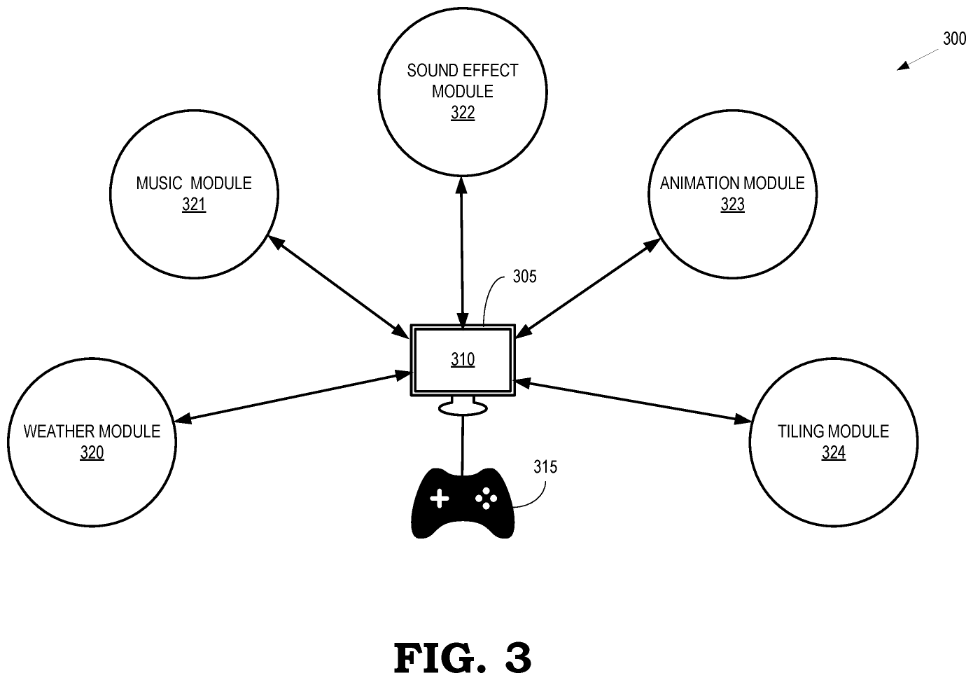

FIG. 3 is a block diagram of a gaming system 300 that includes a set of modules for providing different environmental conditions within a video game executing on the gaming system 300 according to some embodiments. The gaming system 300 includes a display 305 that displays images or video on a screen 310 and a game controller 315 that is used by a player to provide input to control the video game. As discussed herein, the gaming system 300 also includes one or more processors and memories (not shown in FIG. 3 in the interest of clarity). The processors execute instructions such as program code stored in the memories and the processors store information in the memory such as the results of the executed instructions.

The gaming system 300 uses a set of modules 320, 321, 322, 323, 324 (referred to collectively herein as “the modules 320-324”) to provide different environmental conditions that are experienced by the player within the context of the video game. In the illustrated embodiment, the module 320 generates weather effects such as sun, clouds, rain, snow, thunder, lightning, and the like. The module 321 generates music that is by the player during the video game and the module 322 generates sound effects heard by the player such as the sound of footsteps, the various sounds associated with weapons, and the like. The module 323 generates animations for other characters such as non-player characters (NPCs) that are walking, running, attacking, falling, and the like. Some embodiments of the module 323 also generate animations for cut scenes. The module 324 generates characteristics of procedural world tiles that represent a map of an area being explored by the player. The characteristics can include different types and density of vegetation, animals or other creatures that populate the procedural world tile, geological features, and the like.

Each of the module 320-324 implements a state machine that includes a set of states to represent different environmental conditions generated by the corresponding module 320-324. The state machines transition between the different states in response to changes in the game context so that the environmental conditions generated by the modules 320-324 correspond to or reflect the altered game context. The states of the state machines are associated with natural language tags. Some embodiments of the modules 320-324 implement (or have access to) a semantic NLP ML algorithm that ranks the tags based on their semantic similarity to an input phrase. The modules 320-324 determine transitions between the states based on the rankings generated by the semantic NLP ML algorithm in response to receiving an input phrase. For example, the modules 320-324 can select state associated with the highest ranked tag, which indicates that the selected tag has the highest degree of semantic similarity to the input phrase.

Some embodiments of the modules 320-324 monitor predetermined subsets of sources of natural language phrases. The predetermined subsets monitored by each of the modules 320-324 can be different than (or overlapping with) the predetermined subsets monitored by the other modules 320-324. The modules 320-324 detect a natural language phrase generated by one of the predetermined subsets of sources and provide the detected natural language phrase as the input phrase to the semantic NLP ML algorithm. Some embodiments of the modules 320-324 modify the ranking generated by the semantic NLP ML algorithm based on alternate associations of phrases that represent the game state and the tags for the states of the state machines implemented by the module 320-324. For example, the module 320 can define one or more rules that bias the rankings of the tags to modify their semantic association with the phrases that represent the game state. In that case, the module 320 modifies the ranking based on the one or more rules during a post-processing phase.

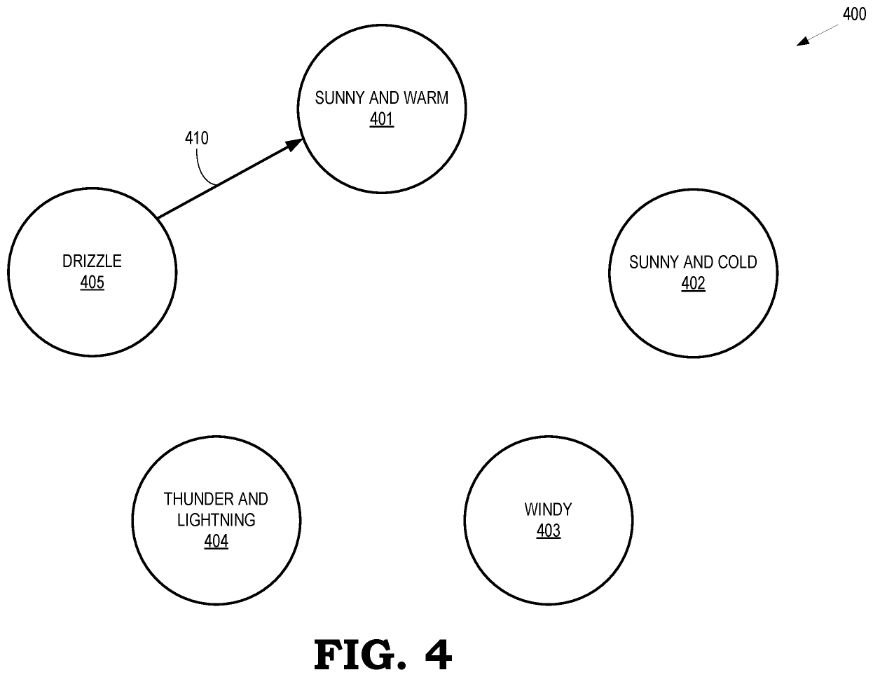

FIG. 4 is a block diagram of a state machine 400 implemented in a module of a video game according to some embodiments. The state machine 400 represents some embodiments of the module 320 shown in FIG. 3 and is therefore configured to generate weather effects in the video game. The state machine 400 includes a state 401 that is associated with the game settings for a sunny and warm climate, a state 402 that is associated with the game settings for a sunny and cold climate, a state 403 that is associated with the game settings for a windy climate, a state 404 that is associated with the game settings for thunder and lightning in the environment, and a state 405 that is associated with the game settings for drizzly weather. Some embodiments of the state machine 400 include more or different states to represent other weather conditions or effects.

The states 401-405 are tagged with natural language phrases that are indicative of their associated game settings. The tags for the states 401-405 are shown in Table 1.

TABLE 1

| TAG | SETTINGS |
|---|---|
| Sunny and Warm | Bright light |
| | Blue sky |
| | Light breeze |
| | 75° temperature |
| Sunny and cold | Bright light |
| | Blue sky |
| | No breeze |
| | 30° temperature |
| Windy | Bright light |
| | Blue sky |
| | Little fluffy clouds |
| | Gusty winds |
| | 50° temperature |
| Thunder and Lightning | Very low light |
| | Heavy dark clouds |
| | Gusty breeze |
| | 60° temperature |
| | Heavy slashing rain |
| | Random lightning flashes followed |
| | by thunder |
| Drizzle | Low light |
| | Grey low-lying clouds |
| | No breeze |
| | 65° temperature |
| | Steady light rain |

The state machine 400 transitions between the different states 401-405 in response to changes in the game context, which are indicated by input natural language phrases. The state machine 400 compares the input phrase to the tags associated with the states 401-405 and selects a new state 401-405 based on the semantic similarity of the input phrase and the tag associated with the selected state. In some embodiments, a semantic NLP ML algorithm operating in the semantic similarity modality ranks the tags (and the associated states 401-405) based on their semantic similarity to the input phrase. For example, the semantic NLP ML algorithm may rank the tag “sunny and warm” as the most similar to an input phrase “what a beautiful day,” and give progressively lower rankings to the tags “sunny and cold,” “windy,” “drizzle,” and “thunder and lightning.” Based on the ranking, the state machine 400 transitions between the states 401-405. For example, if the state machine 400 is in the state 405 and the input phrase is “I'm so glad the sun has come out,” the state machine 400 could transition to the state 401 (as indicated by the arrow 410) from the state 405 based on the semantic similarity of “sunny and warm” to “I'm so glad the sun has come out.”

In general, the state machine 400 comprises a state 410 that is associated with a game setting, i.e. the group of variables to be set within the game, which as a group can be called and identified with a tag (i.e. a data structure or a label).

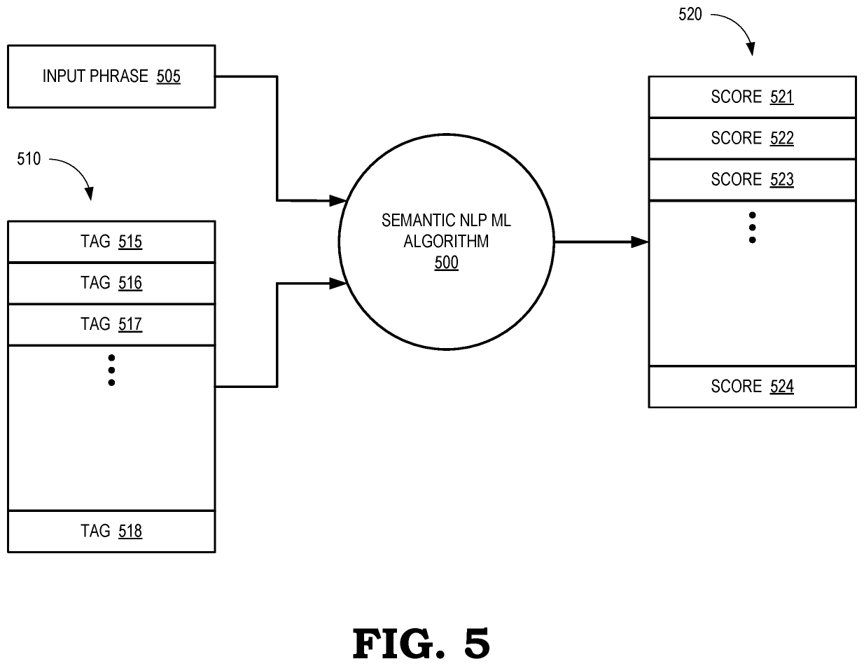

FIG. 5 is a block diagram of an instance of a semantic NLP ML algorithm 500 that generates initial scores for responses to an input phrase 505 according to some embodiments. The semantic NLP ML algorithm 500 is instantiated by some embodiments of the CPU 115 and the GPU 150 shown in FIG. 1 and the processors 220, 240 shown in FIG. 2. As discussed herein, the semantic NLP ML algorithm 500 is pre-trained using one or more text corpuses. The input phrase 505 is provided to the semantic NLP ML algorithm 500, e.g., in response to a user providing the phrase in a form that is converted to text such as typing, cutting-and-pasting, using speech recognition software, using optical character recognition software, and the like. The input phrase 505 can also be generated by the gaming system that implements the semantic NLP ML algorithm 500, e.g., by the modules 320-324 shown in FIG. 3.

In the illustrated embodiment, the semantic NLP ML algorithm 500 is implemented in (or accessible to) the modules 320-324 shown in FIG. 3. Each of the modules 320-324 uses the semantic NLP ML algorithm 500 in semantic similarity mode to compare the input phrase 505 to a corresponding set 510 of tags 515, 516, 517, 518 (collectively referred to herein as “the tags 515-518”) that are associated with states of a state machine implemented in the module. The set 510 is predetermined by a developer, dynamically generated by program code such as that used to implement a game or selected/generated using other techniques. The set 510 is provided to the semantic NLP ML algorithm 500.

In the illustrated embodiment, the semantic NLP ML algorithm 500 operates in the semantic similarity modality and therefore generates a ranking 520 based on scores 521, 522, 523, 524 (collectively referred to herein as “the scores 521-524”) that indicate semantic similarities of the tags 515-518 to the input phrase 505. For example, the semantic NLP ML algorithm 500 can compare an input phrase 505 of “what a beautiful day” to the tag 515 of “sunny and warm,” the tag 516 of “sunny and cold,” the tag 517 of “windy,” and the tag 518 of “thunder and lightning.” In that case, the semantic NLP ML algorithm 505 returns a relatively high score 521 (e.g., a score close to 1.0) for the tag 515 and relatively low scores 522-524 for the tags 516-518, such as scores that get progressively closer to 0.0. The semantic NLP ML algorithm 500 that generates the ranking 520 of the responses 515-518 based on the scores 520-523.

Pre-training the semantic NLP ML algorithm 500 on conventional text corpuses causes the semantic NLP ML algorithm 500 to generate higher scores 521-524 for tags that are consistent with conventional usage or interpretation of the terms in the input phrase 505 and the tags 515-518. However, some embodiments of the semantic NLP ML algorithm 500 are implemented in other contexts that rely on unconventional usage or interpretations of some phrases. For example, as discussed herein, many game worlds purposely redefine concepts to contrast with their real-world interpretations. Post-processing of the results provided by the semantic NLP ML algorithm 500 is therefore used to modify the initial scores 521-524 based on one or more rules that redefine the associations between the input phrase 505 and the tags 515-518.

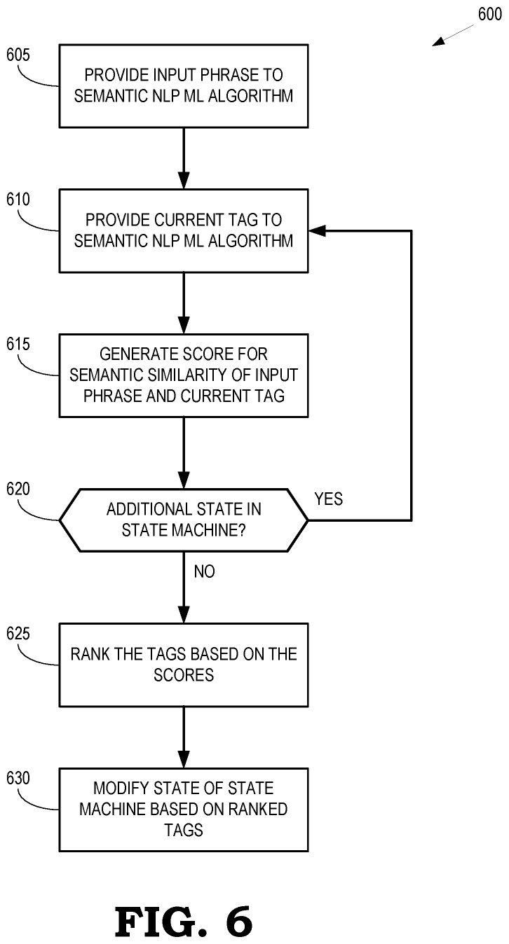

FIG. 6 is a flow diagram of a method 600 of modifying the state of a state machine that represents environmental conditions in a video game based on ranked tags of the states of the state machine according to some embodiments. The method 600 is implemented in a module such as some embodiments of the modules 320-324 in the gaming system 300 shown in FIG. 3. As discussed herein, the module implements (or has access to) a semantic NLP ML algorithm that operates in the semantic similarity modality.

At block 605, the module receives an input phrase and provides the input phrase to the semantic NLP ML algorithm. The input phrase is generated in response to player input (e.g., via a controller) or by one or more entities implemented in the gaming system, as discussed herein.

At block 610, a current tag for a state of the state machine is provided to the semantic NLP ML algorithm, which compares the current tag to the input phrase and generates (at block 615) a score that represents the semantic similarity of the input phrase and the current tag.

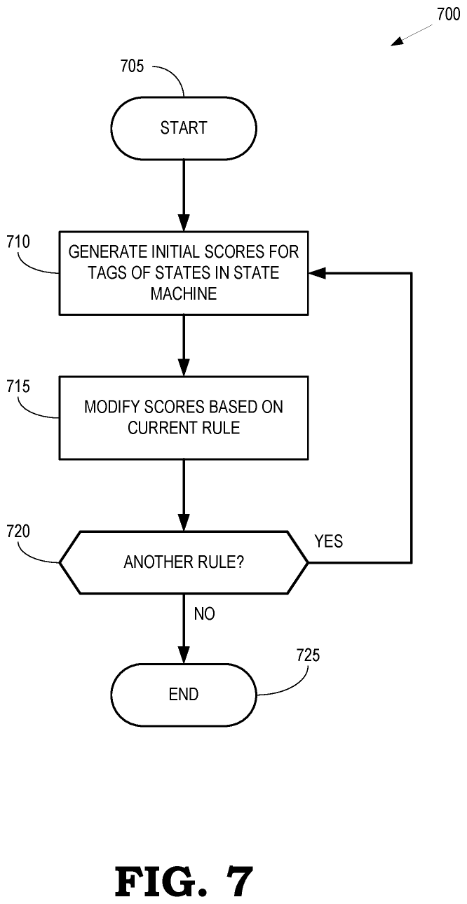

As discussed below with regard to FIG. 7, post-processing based on rules can be used to modify the scores generated by the semantic NLP ML algorithm.

At decision block 620, the module determines whether there are additional states in the state machine. If so, the method 600 flows back to the block 610 and another state is chosen as the current state with a corresponding current tag. If not, the method 600 flows to block 625.

At block 625, the module ranks the tags based on the scores returned by the semantic NLP ML algorithm. At block 630, the module modifies the state of the state machine based on the ranked tags. Some embodiments of the module choose the state associated with the highest ranked tag and then because the state machine to transition to the chosen state. The module then provides environmental conditions corresponding to the game settings of the chosen state so that the player experiences the modified environmental conditions that result from transitioning between states of the state machine of the module.

FIG. 7 is a flow diagram of a method 700 for re-ranking results returned by a semantic NLP ML algorithm for a set of rules according to some embodiments. The method 700 is implemented in a processor that executes one or more instances of the semantic NLP ML algorithm such as some embodiments of the CPU 115 and the GPU 150 shown in FIG. 1, the processors 220, 240 shown in FIG. 2, and the gaming system 300 shown in FIG. 3.

The method 700 starts at block 705. At block 710, the semantic NLP ML algorithm generates initial scores for a set of tags by comparing the candidate tags to an input phrase. The semantic NLP ML algorithm is operating in the semantic similarity modality in block 710.

At block 715, scores are modified based on the current rule. In some embodiments, modifying the scores includes determining a bias based on the current rule and adding the bias to the scores. The modifications produced by rules in the set of rules considered by the method 700 are cumulative and so re-ranking based on each of the rules “stacks” with the re-ranking based on the other rules in the set. Some embodiments of techniques for re-ranking of the results from a semantic NLP ML algorithm are disclosed in International Patent Application Serial No. PCT/US2020/030646 (Attorney Docket No. G20005), entitled “Re-Ranking Results from Semantic Natural Language Processing Machine Learning Algorithms for Implementation in Video Games,” and filed on Apr. 30, 2020, the entirety of which is incorporated by reference herein.

At decision block 720, the method 700 determines whether there are additional rules in the set to consider. If so, the method 700 flows to block 710 and a new rule from the set is considered as the current rule. If not, the method 700 flows to block 725 and the method 700 ends.

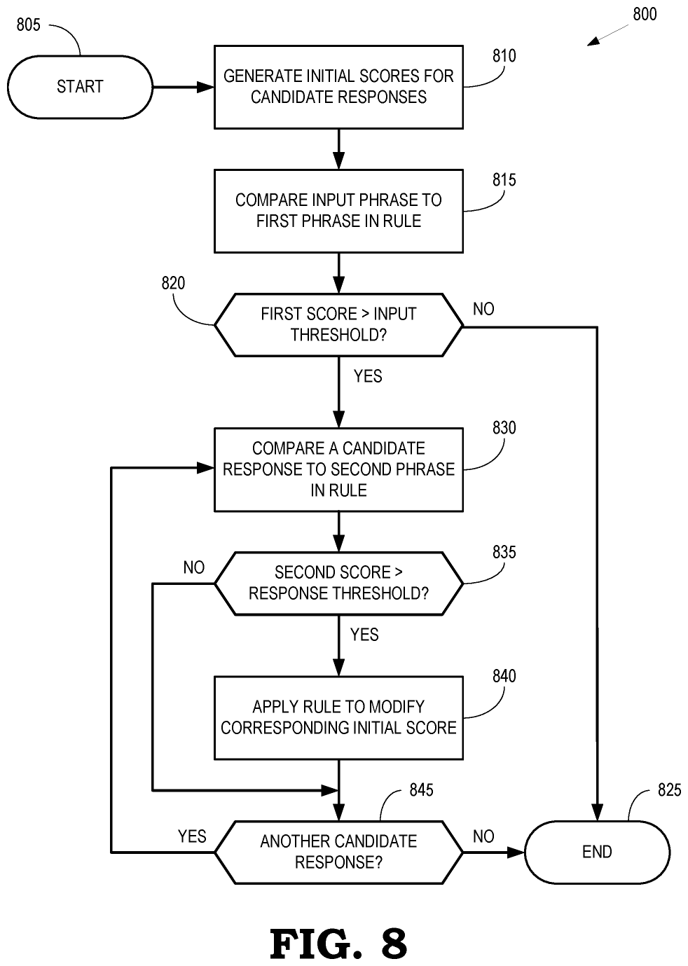

FIG. 8 is a flow diagram of a method 800 for re-ranking results returned by a semantic NLP ML algorithm for a single rule according to some embodiments. The method 800 is implemented in a processor that executes one or more instances of the semantic NLP ML algorithm such as some embodiments of the CPU 115 and the GPU 150 shown in FIG. 1 and the processors 220, 240 shown in FIG. 2.

The method 800 starts at block 805. At block 810, the semantic NLP ML algorithm generates initial scores for a set of candidate responses by comparing the candidate responses to an input phrase. The semantic NLP ML algorithm is operating in the input/response modality in block 810.

At block 815, the semantic NLP ML algorithm compares the input phrase to a first phrase in a rule. The semantic NLP ML algorithm is operating in the semantic similarity modality in block 815 and therefore returns a score indicating the semantic similarity of the input phrase and the first phrase in the rule.

At decision block 820, the processor determines whether the first score exceeds the input threshold defined by the rule. If the first score is less than the input threshold, the method 800 flows to the block 825 and the method 800 ends without the rule being applied to modify the initial scores generated by the semantic NLP ML algorithm. If the score is greater than the input threshold, the method 800 flows to the block 830.

At block 830, the semantic NLP ML algorithm compares one of the candidate responses to the second phrase in the rule. The semantic NLP ML algorithm returns a score indicating the semantic similarity of the candidate response and the second phrase.

At decision block 835, the processor determines whether the second score exceeds the response threshold defined by the rule. If the second score is greater than the input threshold, the method 800 flows to the block 840. If the second score is less than or equal to the input threshold, the method 800 flows to the decision block 845.

At block 840, the rule is applied to modify the corresponding initial score. In some embodiments, applying the rule includes calculating an input weight and a response weight. A total bias is then calculated based on the input weight, the response weight, and a bias indicated in the rule. The total bias is added to the initial score to determine the final modified score.

At block 845, the processor determines whether there is another candidate response in the set of candidate responses. If so, the method 800 flows to the block 830 and another candidate response is considered. If not, the method 800 flows to block 825 and the method 800 ends.

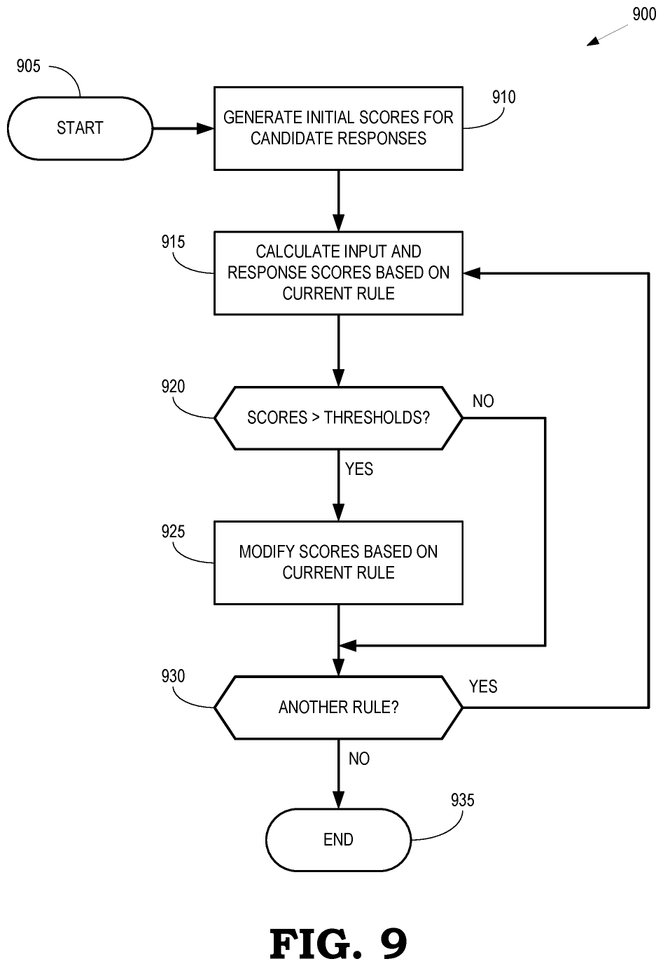

FIG. 9 is a flow diagram of a method 900 for re-ranking results returned by a semantic NLP ML algorithm for a set of rules according to some embodiments. The method 900 is implemented in a processor that executes one or more instances of the semantic NLP ML algorithm such as some embodiments of the CPU 115 and the GPU 150 shown in FIG. 1 and the processors 220, 240 shown in FIG. 2.

The method 900 starts at block 905. At block 910, the semantic NLP ML algorithm generates initial scores for a set of candidate responses by comparing the candidate responses to an input phrase. The semantic NLP ML algorithm is operating in the input/response modality in block 910.

At block 915, the semantic NLP ML algorithm calculates input and response scores using a current rule being considered by the method 900 at the current iteration. In some embodiments, the method 900 calculates the input and response scores as discussed above, e.g., with regard to FIG. 8. The semantic NLP ML algorithm is operating in the semantic similarity modality in block 915 and therefore returns scores indicating the semantic similarity of the input phrase and the first phrase in the current rule and indicating the semantic similarity of the response phrase and the second phrase in the current rule.

At decision block 920, the method 900 determines whether the input and response scores are greater than the corresponding thresholds. If so, the method 900 flows to block 925. If not, the method 900 flows to decision block 930.

At block 925, the scores are modified based on the current rule. In some embodiments, modifying the scores includes determining a bias based on the current rule and adding the bias to the scores, as discussed herein. The modifications produced by rules in the set of rules considered by the method 900 are cumulative and so re-ranking based on each of the rules “stacks” with the re-ranking based on the other rules in the set. The method 900 then flows to block 930.

At block 930, the method 900 determines whether there are additional rules in the set to consider. If so, the method 900 flows to block 910 and a new rule from the set is considered as the current rule. If not, the method 900 flows to block 935 and the method 900 ends.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

In the following some example embodiments are described.

Example 1. A method comprising:
generating, using a module that implements a state machine, a first environmental condition experienced by a player in a video game, wherein the first environmental condition is produced by the module operating in a first state of the state machine, and wherein the first state is associated with a first natural language tag;
transitioning the state machine from the first state to a second state based on a semantic similarity of an input phrase and a second natural language tag associated with the second state; and
generating, using the module operating in the second state, a second environmental condition experienced by the player in the video game.

Example 2. The method of example 1, wherein the first state is associated with a first set of game settings and the second state is associated with a second set of game settings that is different than the first set of game settings.

Example 3. The method of example 1 or 2, further comprising:
ranking, using a semantic natural language processing (NLP) machine learning (ML) algorithm, tags for a plurality of states that comprise the first state and the second state based on their semantic similarity to an input phrase.

Example 4. The method of example 3, further comprising:
selecting, at the module, the second natural language tag based on the ranking generated by the semantic NLP ML algorithm.

Example 5. The method of example 3 or 4, further comprising:
monitoring a predetermined subset of sources of natural language phrases associated with the module.

Example 6. The method of at least one of examples 3 to 5, further comprising:
detecting a natural language phrase generated by at least one of the predetermined subset of sources; and
providing the detected natural language phrase as the input phrase to the semantic NLP ML algorithm.

Example 7. The method of at least on of examples 3 to 6, further comprising:
modifying the ranking generated by the semantic NLP ML algorithm based on at least one alternate association of phrases that represent the game state and the tags for the plurality of states.

Example 8. The method of example 7, further comprising:
defining at least one rule that biases the rankings of the tags to modify their semantic association with the phrases that represent the game state; and
wherein modifying the ranking generated by the semantic NLP ML algorithm comprises modifying the ranking based on the at least one rule.

Example 9. An apparatus, comprising:
a memory configured to store a first program code representative of a module that implements a state machine; and
a processor configured to execute the module to generate a first environmental condition experienced by a player in a video game, wherein the first environmental condition is produced by the module operating in a first state of the state machine, and wherein the first state is associated with a first natural language tag, the processor also configured to transition the state machine from the first state to a second state based on a semantic similarity of an input phrase and a second natural language tag associated with the second state, and generate, using the module operating in the second state, a second environmental condition experienced by the player in the video game.

Example 10. The apparatus of example 9, wherein the first state is associated with a first set of game settings and the second state is associated with a second set of game settings that is different than the first set of game settings.

Example 11. The apparatus of example 9 or 10, wherein the memory is configured to store a second program code representative of a semantic natural language processing (NLP) machine learning (ML) algorithm.

Example 12. The apparatus of example 11, wherein the processor is configured to execute the semantic NLP ML algorithm to rank tags for a plurality of states that comprise the first state and the second state based on their semantic similarity to an input phrase.

Example 13. The apparatus of example 12, wherein the module is configured to select the second natural language tag based on the ranking generated by the semantic NLP ML algorithm.

Example 14. The apparatus of at least one of the examples 9 to 13, wherein the module is configured to monitor a predetermined subset of sources of natural language phrases associated with the module.

Example 15. The apparatus of example 14, wherein the module is configured to detect a natural language phrase generated by at least one of the predetermined subset of sources.

Example 16. The apparatus of example 14 or 15, wherein the module is configured to provide the detected natural language phrase as the input phrase to the semantic NLP ML algorithm.

Example 17. The apparatus of at least one of the examples 12 and 16, wherein the processor is configured to modify the ranking generated by the semantic NLP ML algorithm based on at least one alternate association of phrases that represent the game state and the tags for the plurality of states.

Example 18. The apparatus of example 17, wherein the memory is configured to store at least one rule that biases the rankings of the tags to modify their semantic association with the phrases that represent the game state.

Example 19. The apparatus of example 17 or 18, wherein the processor is configured to modify the ranking based on the at least one rule.

20. A non-transitory computer readable medium embodying a set of executable instructions, the set of executable instructions to manipulate at least one processor to perform the method of any of examples 1 to 8.

Example 21. A system to perform the method of any of examples 1 to 8.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
generating, using a module that implements a state machine, a first environmental condition experienced by a player in a video game, wherein the first environmental condition is produced by the module operating in a first state of the state machine, and wherein the first state is associated with a first natural language tag;
transitioning the state machine from the first state to a second state based on a semantic similarity of an input phrase and a second natural language tag associated with the second state; and
generating, using the module operating in the second state, a second environmental condition experienced by the player in the video game.

2. The method of claim 1, wherein the first state is associated with a first set of game settings and the second state is associated with a second set of game settings that is different than the first set of game settings.

3. The method of claim 1, further comprising:
ranking, using a semantic natural language processing (NLP) machine learning (ML) algorithm, tags for a plurality of states that comprise the first state and the second state based on their semantic similarity to an input phrase.

4. The method of claim 3, further comprising:
selecting, at the module, the second natural language tag based on the ranking generated by the semantic NLP ML algorithm.

5. The method of claim 3, further comprising:
monitoring a predetermined subset of sources of natural language phrases associated with the module.

6. The method of claim 3, further comprising:
detecting a natural language phrase generated by at least one of the predetermined subset of sources; and
providing the detected natural language phrase as the input phrase to the semantic NLP ML algorithm.

7. The method of claim 3, further comprising:
modifying the ranking generated by the semantic NLP ML algorithm based on at least one alternate association of phrases that represent the game state and the tags for the plurality of states.

8. The method of claim 7, further comprising:
defining at least one rule that biases the rankings of the tags to modify their semantic association with the phrases that represent the game state; and
wherein modifying the ranking generated by the semantic NLP ML algorithm comprises modifying the ranking based on the at least one rule.

9. An apparatus, comprising:
a memory configured to store a first program code representative of a module that implements a state machine; and
a processor configured to execute the module to generate a first environmental condition experienced by a player in a video game, wherein the first environmental condition is produced by the module operating in a first state of the state machine, and wherein the first state is associated with a first natural language tag, the processor also configured to transition the state machine from the first state to a second state based on a semantic similarity of an input phrase and a second natural language tag associated with the second state, and generate, using the module operating in the second state, a second environmental condition experienced by the player in the video game.

10. The apparatus of claim 9, wherein the first state is associated with a first set of game settings and the second state is associated with a second set of game settings that is different than the first set of game settings.

11. The apparatus of claim 9, wherein the memory is configured to store a second program code representative of a semantic natural language processing (NLP) machine learning (ML) algorithm.

12. The apparatus of claim 11, wherein the processor is configured to execute the semantic NLP ML algorithm to rank tags for a plurality of states that comprise the first state and the second state based on their semantic similarity to an input phrase.

13. The apparatus of claim 12, wherein the module is configured to select the second natural language tag based on the ranking generated by the semantic NLP ML algorithm.

14. The apparatus of claim 9, wherein the module is configured to monitor a predetermined subset of sources of natural language phrases associated with the module.

15. The apparatus of claim 14, wherein the module is configured to detect a natural language phrase generated by at least one of the predetermined subset of sources.

16. The apparatus of claim 14, wherein the module is configured to provide the detected natural language phrase as the input phrase to the semantic NLP ML algorithm.

17. The apparatus of claim 12, wherein the processor is configured to modify the ranking generated by the semantic NLP ML algorithm based on at least one alternate association of phrases that represent the game state and the tags for the plurality of states.

18. The apparatus of claim 17, wherein the memory is configured to store at least one rule that biases the rankings of the tags to modify their semantic association with the phrases that represent the game state.

19. The apparatus of claim 17, wherein the processor is configured to modify the ranking based on the at least one rule.

20. (canceled)

21. (canceled)
